(19) United States
(12) Patent Application Publication
(10) Pub. No.: US 2009/0111322 A1
(43) Pub. Date: Apr. 30, 2009

(54) STRUCTURE FOR MOUNTING CHANDELIER ARMS

(76) Inventor: Ran Roland, Aventura, FL (US)

Correspondence Address: Fleit Gibbons Gutman Bongini & Bianco PL, 21355 EAST DIXIE HIGHWAY, SUITE 115, MIAMI, FL, 33180, US

(21) Appl. No.: 11/575,231

(22) PCT Filed: Sep. 14, 2005
(86) PCT No.: PCT/US05/32661

§ 371 Date: May 13, 2008

Related U.S. Application Data
(60) Provisional application No. 60/609,919, filed on Sep. 14, 2004.

(51) Int. Cl. H01R 13/66; F21S 8/06

(52) U.S. Cl. 439/541; 362/405

(57) ABSTRACT

A quick connect and disconnect device for attaching and detaching an arm (30) of an electrical fixture with a base (22) of the electrical fixture is provided. The device includes a first connection plug (24) attached to the base (22) of the electrical fixture. The first connection plug (22) has an electrical receptacle (42) disposed therein. The device also includes a second connection plug (36) attached to the arm (30) of the electrical fixture. The second connection plug (36) has an electrical protrusion (32) extending therefrom. The electrical protrusion (32) is dimensioned and configured for insertion into the electrical receptacle (42). Furthermore, the device includes a cap (52) positionable about the first and second connection plugs (24, 36) to thereby attach the arm (30) of the electrical fixture to the base (22).

### FIELD OF THE INVENTION

The present invention relates to an electrical fixture and, more particularly, to a chandelier having a quick connect and disconnect device for attaching and detaching chandelier arms to and from a chandelier base and for making electrical connections between the arms and base.

### BACKGROUND OF THE INVENTION

Electrical fixtures, such as chandeliers, can be difficult to package, transport, and assemble. Due the size of these fixtures, they often must be disassembled prior to packaging for shipment. Then, once delivered, they must be painstakingly assembled and carefully hung from the ceiling or other structure.

A one-time, arduous assembly may be tolerable for most owners; however, there may be additional times in which the fixture must be disassembled and reassembled. For example, the owner of the electrical fixture may wish to take the fixture when moving to a new home. Also, the fixture may require maintenance and repair which can not be performed with the fixture hanging from the ceiling. In this case, the fixture will need to be disassembled, packaged, and taken to a repair facility. Furthermore, such electrical fixtures require periodic cleaning. Many chandeliers are too large or complex to clean in place. Therefore, the chandelier will, again, need to be disassembled for proper cleaning then reassembled.

Therefore, there is a need for an electrical fixture, such as a chandelier, which can be easily and quickly assembled and/or disassembled for transportation, maintenance, and cleaning.

### SUMMARY OF THE INVENTION

The present invention provides a quick connect and quick disconnect device for assembling an electrical fixture having one or more appendages, such as a chandelier. The device connects the appendage to the base of the electrical fixture to form mechanical and electrical connections between the appendage and base.

In accordance with one aspect of the present invention, there is provided a quick connect and disconnect device for attaching and detaching an arm of an electrical fixture with a base of the electrical fixture. The device includes a first connection plug attached to the base of the electrical fixture. The first connection plug may be attached to the base by threads, a clip, a clamp, a weld, and/or nut and bolt. The first connection plug has an electrical receptacle disposed therein. The device also includes a second connection plug attached to the arm of the electrical fixture. The second connection plug has an electrical protrusion extending therefrom. The electrical protrusion is dimensioned and configured for insertion into the electrical receptacle. The device further includes a cap positionable about the first and second connection plugs to thereby attach the arm of the electrical fixture to the base.

The first connection plug may have a threaded outer surface while the cap may have a threaded inner surface. When the cap is slidably and rotatably disposed about the arm of the electrical fixture, the cap may be positionable about the second connection plug and threadable onto the first connection plug. The cap may also include a rim located around an opening through which the arm of the chandelier is disposed. In this configuration, the rim and cap support the second connection plug when the cap is threaded onto the first connection plug.

The first connection plug may further include a plurality of electrical receptacles disposed therein, and the second connection plug may include a plurality of electrical protrusions extending therefrom. The plurality of electrical protrusions may be dimensioned and configured for insertion into the plurality of electrical receptacles.

Each electrical receptacle may include an annular recess and an electric contact disposed within the annular recess, while each electrical protrusion may include an annular electrode. Each annular electrode may be dimensioned and configured for insertion into one of the annular recesses and for association with one of the electric contacts.

Alternatively, or in addition, each electrical receptacle may include a cylindrical recess and an electric contact disposed with the cylindrical recess, while each electrical protrusion may include a cylindrical prong. Each cylindrical prong may be dimensioned and configured for insertion into one of the cylindrical recesses and for association with one of the electric contacts.

The first connection plug may further include a non-slip surface disposed adjacent to one of the annular recesses, while the second connection plug may include a non-slip surface disposed adjacent to one of the annular electrodes. The non-slip surfaces of the first and second connection plugs may be engagable when the connection plugs are connected to each other to thereby prevent rotation of the connection plugs relative to each other.

In another aspect of the present invention, there is provided an electrical fixture including a base, a plurality of appendages, and a plurality of quick connect and disconnect devices. Each appendage may be attached to the base by at least one of the quick connect and disconnect devices. The base of the fixture may include a chandelier globe, and the plurality of appendages include a plurality of chandelier arms. For example, four chandelier arms may be connected with the chandelier globe. Each chandelier arm may be connected mechanically and electrically to the chandelier globe through at least one quick connect and disconnect device.

### BRIEF DESCRIPTION OF THE DRAWINGS

A more complete understanding of the present invention, and the attendant advantages and features thereof, will be more readily understood by reference to the following detailed description when considered in conjunction with the accompanying drawings wherein:

FIG. 1 is a perspective view of a base of a chandelier of the present invention;

FIG. 2 is a perspective view of a plurality of chandelier arms connectable to the base;

FIG. 3 is a perspective view of an assembled chandelier of the present invention;

FIG. 4 is a perspective view of an exemplary embodiment of a quick connect and disconnect device for attaching and detaching a chandelier arm to a chandelier base;

FIG. 5 is a perspective view of a male portion of the device of FIG. 4;

FIG. 6 is a perspective view of another exemplary embodiment of a quick connect and disconnect device for attaching and detaching a chandelier arm to a chandelier base; and

FIG. 7 is another perspective view of the device of FIG. 6.

### DETAILED DESCRIPTION OF THE INVENTION

The present invention provides a quick connect and quick disconnect device for assembling an electrical fixture having one or more appendages, such as a chandelier. The device connects the appendage to the base of the electrical fixture to form mechanical and electrical connections between the appendage and base.

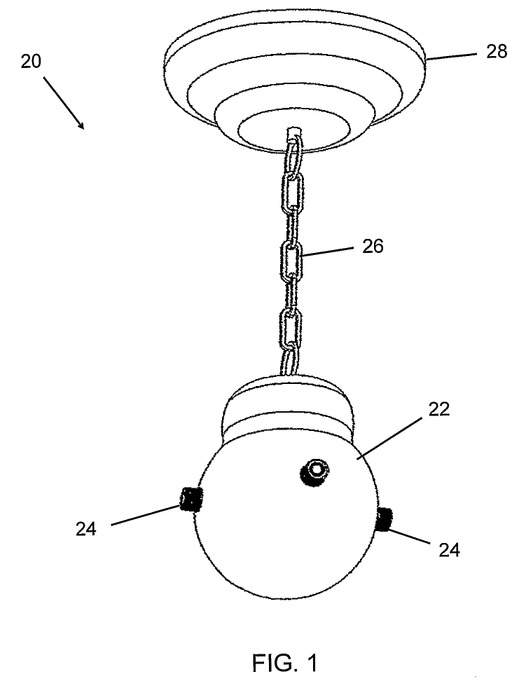

Referring now to the drawing figures in which like reference designators refer to like elements, there is shown in FIG. 1 a portion of a chandelier 20. The chandelier 20 includes a base or globe 22 having one or more female connection ports 24 for receiving one or more appendages or arms (not shown). The chandelier base 22 is suspended from the ceiling with a chain 26 which is attached to a sturdy structure, like a junction box or beam, in the ceiling. An electrical wire (not shown) runs parallel to or is weaved through the chain 26 from the ceiling to the base 22. A plate 28 covers the mounting hardware in the ceiling.

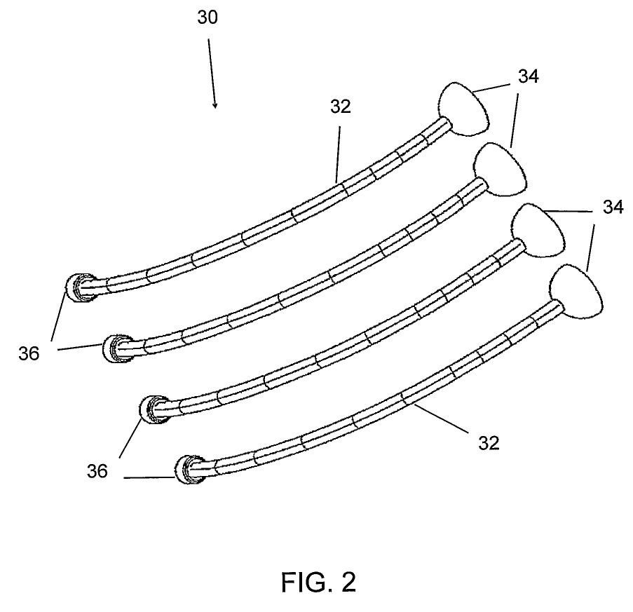

In FIG. 2, a plurality of chandelier arms 30 is shown. Each arm 30 includes an elongated member 32 having a light socket 34 and a male connection port 36. The male connection port 36 of each arm 30 is dimensioned and configured to be coupled with one of the female connection ports 24 of the chandelier base 22. Although each arm 30 of FIG. 2 is shown with only one light socket 34, it is contemplated that two or more sockets 34 may be attached to each arm 30. Also, each arm 30 may include two or more male connection ports 36. In this configuration, more electrical amperage may be provided to the arm 30 and/or a heavier arm may be attached to the base 22 with the weight of the arm 30 distributed between two or more female and male connection ports 24 and 36.

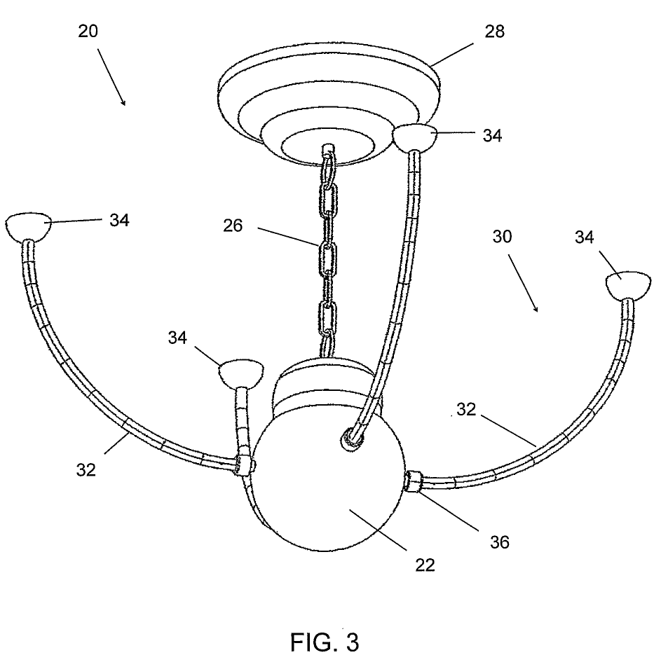

With the chandelier arms 30 attached to the base 22, a fully assembled chandelier 20 is shown in FIG. 3. Each arm 30 is coupled to the base 22 by the female and male connection ports 24 and 36. The connection ports 24 and 36 not only securely affix each arm 30 to the base 22 but also provide for the connection of necessary electrical wires. Not shown in FIG. 3, two or more electrical wires extend from the junction box behind the cover plate 28 to the base 22. Inside the base 22, the wires are connected to the female connection ports 24. Also, two or more electrical wires extend through the elongated member 32 of each arm 30 connecting the light socket 34 with the male connection port 36 of each arm 30. Therefore, when each arm 30 is attached to the base 22, an electrical circuit is created to each of the light sockets 34 of the chandelier arms 30.

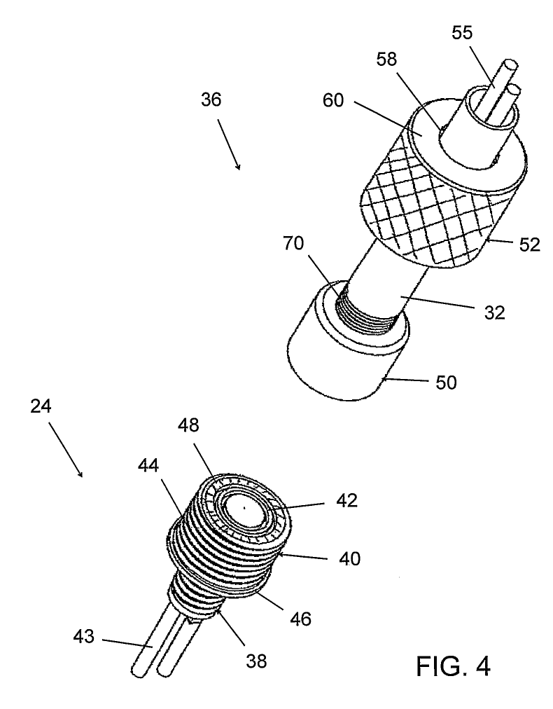

FIG. 4 illustrates an exemplary embodiment of the quick connect and quick disconnect device with the female connection port 24 of the base 22 and the male connection port 36 of one of the arms 30. The female connection port 24 has a generally cylindrical shape. A proximal portion 38 of the connection port 24 is configured for attachment to the base 22. The proximal portion 38 may be threaded as shown in FIG. 4 or, alternatively, may include a different attachment means such as a weld, a clip, a clamp, nut and bolt, or similar fastener. The distal portion 40 of the connection port 24 includes two or more annular receptacles or recesses 42. Within each receptacle 42 is an electrical contact (not shown). Two or more electrical wires 43 extend through a longitudinal channel in the proximal portion 38 and into the distal portion 40 where the electrical wires 43 are connected with the electrical contacts of the annular receptacles 42. The distal portion 40 of the connection port 24 may include a threaded outer surface 44, a circumferential flange 46 disposed on the outer surface, and a ratchet-like shaped, non-slip annulus 48 adjacent the annular receptacle 42.

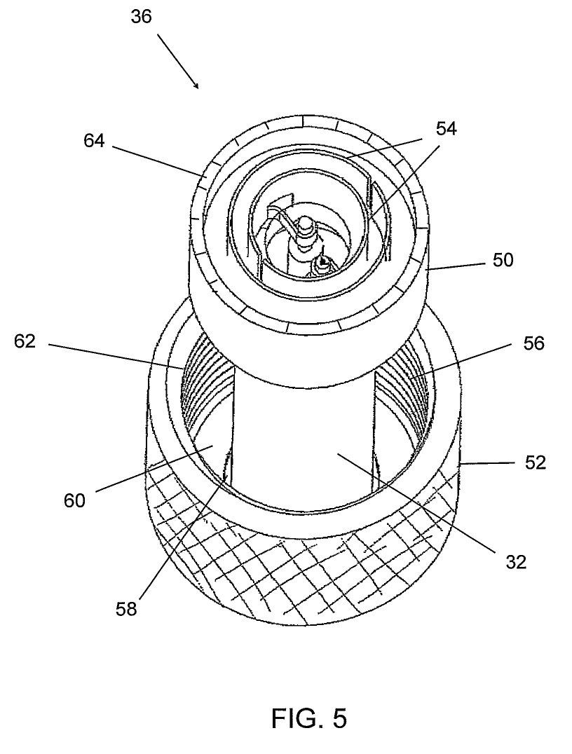

Shown in FIGS. 4 and 5 is the male connection port 36 of the chandelier arm 30. The male connection port 36 includes inner and outer portions 50 and 52. The inner portion 50, or contact piece, is generally cylindrical in shape and has two or more annular electrodes 54. The inner portion 50 of the connection port 36 is attached to the elongated member 32 of the chandelier arm 30 by threads 70. The annular electrodes 54 of the inner portion 50 are connected to two or more wires 55 located within the elongated member 32 of the arm 30. The annular electrodes 54 are dimensioned and configured to be positioned within the annular receptacles 42 and positioned against the electrical contacts of the female connection port 24 to thereby complete the electrical circuit from the junction box in the ceiling to the light socket 34 on the chandelier arm 30.

The outer portion 52 of the male connection port 36 is generally cylindrical in shape and has a threaded interior surface 56, like a bottle cap. At one end, the outer portion or cap 52 includes an opening 58 which has a diameter being slightly larger than the outer diameter of the elongated member 32 of the chandelier arm 30. The end of the cap 52 also includes a lip or rim 60 surrounding the opening 58. At the other end, the cap 52 has an opening 62 which has a diameter approximately the diameter of the distal portion 40 of the female connection port 24. The cap 52 is slidably and rotatably disposed about the elongated member 32 of the chandelier arm 30 through the openings 58 and 62 of the cap 52. In this configuration, the cap 52 of the male connection port 36 may be screwed or threaded onto the distal portion 40 of the female connection port 24 to thereby seat the annular electrodes 54 into the annular receptacles 42 and secure the chandelier arm 30 to the chandelier base 22.

The weight of the chandelier arm 30 is properly supported by the base 22 by way of the female and male connection ports 24 and 36. That is, the cap 52, when firmly screwed in to the flange 46, presses the female and male connection ports 24 and 36 together. The cap 52 and the rim 60 firmly support the elongated member 32 of the arm 30 and the inner portion 50 of the male connection port 36. As further illustrated in FIG. 5, the inner portion 50 of the male connection port 36 may include a ratchet-like shaped, non-slip annulus 64. When the connection ports 24 and 36 are mated, the non-slip annulus 64 of the male connection port 36 engages the non-slip annulus 48 of the female connection port 24. This feature prevents undesired rotation of the chandelier arm 30 in relation to the base 22 when the chandelier 20 is assembled.

The female and male connection ports 24 and 36 previously described may further include all or some of the features disclosed in U.S. patent application Ser. No. 10/021,568 filed Dec. 12, 2001 and entitled “Revolvable Plug and Socket.” U.S. patent application Ser. No. 10/021,568 is hereby incorporated by reference.

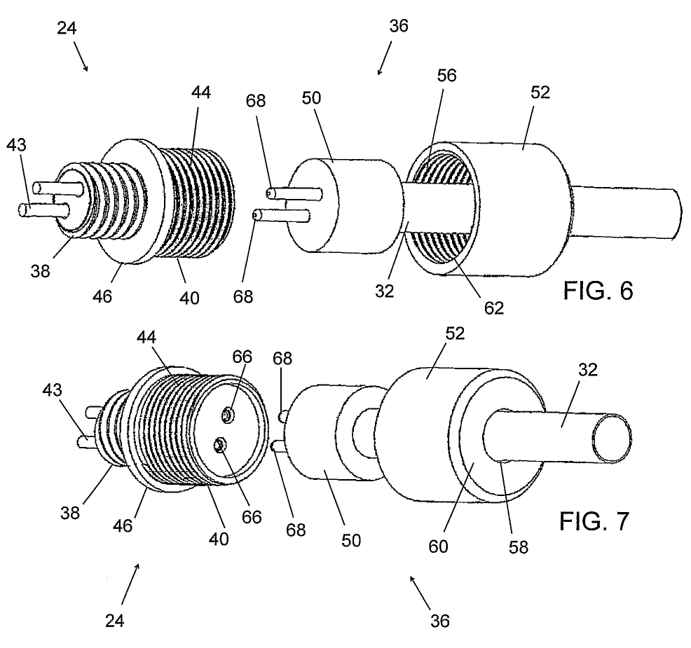

Another exemplary embodiment of the quick connect and disconnect device is shown in FIGS. 6 and 7. The female and male connection ports 24 and 36 of this exemplary embodiment include many of the characteristics of the previously described embodiment. Accordingly, the female connection port 24 includes proximal and distal portions 38 and 40. The proximal portion 38 is threaded for mounting to the chandelier base 22. The distal portion 40 of the connection port 24 includes two or more cylindrical receptacles or recesses 66. Within each receptacle 66 is an electrical contact (not shown). Two or more electrical wires 43 extend through a longitudinal channel in the proximal portion 38 and into the distal portion 40 where the electrical wires 43 are connected with the electrical contacts of the receptacles 66. The distal portion 40 of the female connection port 24 may include a threaded outer surface 44 and a circumferential flange 46 disposed on the outer surface.

The male connection port 36 of the chandelier arm 30 includes an inner portion 50 and an outer portion or cap 52. The inner portion 50, or contact piece, is generally cylindrical in shape and has two or more electrode prongs 68 extending from one end. At the other end, the contact piece 50 is attached to the elongated member 32 of the chandelier arm 30. The electrode prongs 68 are connected to two or more wires (not shown) located within the elongated member 32 of the arm 30. Furthermore, the electrode prongs 68 are dimensioned and configured to be positioned within the cylindrical receptacles 66 and positioned against the electrical contacts of the female connection port 24 to thereby complete the electrical circuit from the junction box in the ceiling to the light socket 34 on the chandelier arm 30.

The cap 52 of the male connection port 36 is generally cylindrical in shape and has a threaded interior surface 56. At one end, the cap 52 includes an opening 58 which has a diameter being slightly larger than the outside diameter of the elongated member 32 of the chandelier arm 30. The end of the cap 52 also includes a lip or rim 60 surrounding the opening 58. At the other end, the cap 52 has an opening 62 which has a diameter approximately the diameter of the distal portion 40 of the female connection port 24. The cap 52 is slidably and rotatably disposed about the elongated member 32 of the chandelier arm 30 through the openings 58 and 62 of the cap 52. In this configuration, the cap 52 of the male connection port 36 may be screwed or threaded onto the distal portion 40 of the female connection port 24 to thereby seat the electrode prongs 68 into the cylindrical receptacles 66 and firmly secure the chandelier arm 30 to the chandelier base 22.

All references cited herein are expressly incorporated by reference in their entirety.

It will be appreciated by persons skilled in the art that the present invention is not limited to what has been particularly shown and described herein above. In addition, unless mention was made above to the contrary, it should be noted that all of the accompanying drawings are not to scale. A variety of modifications and variations are possible in light of the above teachings without departing from the scope and spirit of the invention, which is limited only by the following claims.

What is claimed is:

1. A quick connect and disconnect device for attaching and detaching an arm of an electrical fixture with a base of the electrical fixture, the device comprising:
a first connection plug attached to the base of the electrical fixture, the first connection plug having an electrical receptacle disposed therein;
a second connection plug attached to the arm of the electrical fixture, the second connection plug having an electrical protrusion extending therefrom, the electrical protrusion dimensioned and configured for insertion into the electrical receptacle; and
a cap positionable about the first and second connection plugs to thereby attach the arm of the electrical fixture to the base.

2. The device of claim 1 wherein the cap is slidably and rotatably disposed about the arm of the electrical fixture.

3. The device of claim 2 wherein the first connection plug has a threaded outer surface and the cap has a threaded inner surface.

4. The device of claim 3 wherein the cap is positionable about the second connection plug and is threadable onto the first connection plug

5. The device of claim 4 wherein the first connection plug includes a plurality of electrical receptacles disposed therein and the second connection plug includes a plurality of electrical protrusions extending therefrom, the plurality of electrical protrusions dimensioned and configured for insertion into the plurality of electrical receptacles.

6. The device of claim 5 wherein each electrical receptacle includes an annular recess and an electric contact disposed within the annular recess, and wherein each electrical protrusion includes an annular electrode, each annular electrode dimensioned and configured for insertion into one of the annular recesses and for association with one of the electric contacts.

7. The device of claim 6 wherein the first connection plug is attached to the base by at least one of threads, a clip, a clamp, a weld, and nut and bolt.

8. The device of claim 6 wherein the cap includes a rim located around an opening through which the arm of the chandelier is disposed, the rim and cap supporting the second connection plug when the cap is threaded onto the first connection plug.

9. The device of claim 6 wherein the first connection plug includes a non-slip surface disposed adjacent to one of the annular recesses and wherein the second connection plug includes a non-slip surface disposed adjacent to one of the annular electrodes, the non-slip surfaces of the first and second connection plugs being engagable when the connection plugs are connected to each other to thereby prevent rotation of the connection plugs relative to each other.

10. The device of claim 5 wherein each electrical receptacle includes a cylindrical recess and an electric contact disposed with the cylindrical recess, and wherein each electrical protrusion includes a cylindrical prong, each cylindrical prong dimensioned and configured for insertion into one of the cylindrical recesses and for association with one of the electric contacts.

11. The device of claim 10 wherein the first connection plug is attached to the base by at least one of threads, a clip, a clamp, a weld, and nut and bolt.

12. The device of claim 10 wherein the cap includes a rim located around an opening through which the arm of the chandelier is disposed, the rim and cap supporting the second connection plug when the cap is threaded onto the first connection plug.

13. An electrical fixture comprising a base, a plurality of appendages, and a plurality of quick connect and disconnect devices of claim 1, each appendage attached to the base by at least one of the quick connect and disconnect devices.

14. The fixture of claim 13 wherein the base includes a chandelier globe and the plurality of appendages includes a plurality of chandelier arms.

15. The fixture of claim 14 wherein four chandelier arms are connected with the chandelier globe.

16. The fixture of claim 15 wherein each chandelier arm is connected mechanically and electrically to the chandelier globe through at least one quick connect and disconnect device.
